(19) United States
(12) Patent Application Publication
(10) Pub. No.: US 2026/0286958 A1
(43) Pub. Date: Sep. 24, 2026

(54) SIGNAL CONTROL METHOD, SIGNAL CONTROL APPARATUS, SIGNAL CONTROL DEVICE, STORAGE MEDIUM, AND COMPUTER PROGRAM PRODUCT

(71) Applicant: RISUN TECHNOLOGY (SHENZHEN) LIMITED, Shenzhen (CN)

(72) Inventors: Fei WEI, Shenzhen (CN); Chugang CHEN, Shenzhen (CN); Chuanzhou ZHENG, Shenzhen (CN); Dongbao LI, Shenzhen (CN)

(73) Assignee: RISUN TECHNOLOGY (SHENZHEN) LIMITED, Shenzhen (CN)

(21) Appl. No.: 19/564,409

(22) Filed: Mar. 12, 2026

(30) Foreign Application Priority Data
Mar. 18, 2025 (CN) 202510318311.0

(51) Int. Cl. F04C 14/28; F04C 2/08; G01P 3/481

(52) U.S. Cl. CPC F04C 14/28; F04C 2/084; G01P 3/481; F04C 2270/70

(57) ABSTRACT

A signal control method includes: obtaining a target pulse signal through a Hall sensor based on an interrupt-triggered response mechanism; determining an actual rotation period of a water pump gear based on the target pulse signal, and comparing the actual rotation period with a preset rotation period to obtain a comparison result; and controlling a driving signal according to the comparison result based on a proportional-integral algorithm, where the driving signal is a signal generated based on the target pulse signal.

### CROSS-REFERENCE TO RELATED APPLICATIONS

This application claims priority to Chinese Patent Application No. 202510318311.0, filed on Mar. 18, 2025, the entire contents of which are incorporated herein by reference.

### TECHNICAL FIELD

The present application relates to the technical field of intelligent control, and in particular to a signal control method, a signal control apparatus, a signal control device, a storage medium, and a computer program product.

### BACKGROUND

In the existing signal control technology for water flossers, due to uncertain factors such as assembly tolerances, friction losses, and thermal deformation in the mechanical transmission between the motor and the water pump gear, significant deviations often exist between the actual rotation speed data and the theoretical values, thereby making it impossible to accurately control the driving signal of the water pump.

### SUMMARY

The main purpose of the present application is to provide a signal control method, a signal control apparatus, a signal control device, a storage medium, and a computer program product, aiming to solve the technical problem that the existing technology cannot accurately control the driving signal of a water pump.

In order to solve the above purpose, the present application provides a signal control method, including:
obtaining a target pulse signal through a Hall sensor based on an interrupt-triggered response mechanism;
determining an actual rotation period of a water pump gear based on the target pulse signal, and comparing the actual rotation period with a preset rotation period to obtain a comparison result; and
controlling a driving signal according to the comparison result based on a proportional-integral algorithm, wherein the driving signal is a signal generated based on the target pulse signal.

In an embodiment, the obtaining the target pulse signal through the Hall sensor based on the interrupt-triggered response mechanism includes:
in response to a level state changing, detecting, by the Hall sensor, a pulse signal passing through a magnet based on the interrupt-triggered response mechanism;
filtering out clutter in the pulse signal by a filter capacitor to obtain a processed signal; and
calibrating the processed signal according to an adaptive filtering algorithm to obtain the target pulse signal.

In an embodiment, the calibrating the processed signal according to the adaptive filtering algorithm to obtain the target pulse signal includes:
determining an optimal filter coefficient according to the adaptive filtering algorithm, and adjusting a filter parameter based on the optimal filter coefficient to obtain an optimized signal; and
calibrating the optimized signal by comparing the optimized signal with preset pulse information to obtain the target pulse signal.

In an embodiment, the controlling the driving signal according to the comparison result based on the proportional-integral algorithm includes:
in response to the comparison result indicating that the actual rotation period is greater than the preset rotation period, increasing a duty cycle of the driving signal by using the proportional-integral algorithm;
in response to the comparison result indicating that the actual rotation period is less than the preset rotation period, decreasing the duty cycle of the driving signal by using the proportional-integral algorithm; and
in response to the comparison result indicating that a difference between the actual rotation period and the preset rotation period reaches a preset difference range, performing buffer control on the driving signal by exponential weighted moving average according to a dead-zone control algorithm.

In an embodiment, before the determining the actual rotation period of the water pump gear based on the target pulse signal, and comparing the actual rotation period with the preset rotation period to obtain the comparison result, the method further includes:
in response to detecting that an actual water pressure reaches a target water pressure, obtaining a rotation speed of the water pump gear; and
determining a preset rotation period of the water pump gear according to a corresponding relationship between a rotation speed of the water pump gear and the target water pressure.

In an embodiment, after the controlling the driving signal according to the comparison result based on the proportional-integral algorithm, the method further includes:
identifying an operating state of a motor according to the rotation speed of the water pump gear to obtain an identification result, and adjusting a parameter of the proportional-integral algorithm according to the operating state of the motor to obtain an updated parameter;
in response to the identification result being abnormal, controlling the driving signal in combination with the updated parameter; or
in response to the identification result being abnormal, gradually reducing the rotation speed of the water pump gear through the driving signal until shutdown protection is triggered.

In addition, in order to achieve the above purpose, the present application also provides a signal control apparatus, including:
a signal acquisition module configured to obtain a target pulse signal through a Hall sensor based on an interrupt-triggered response mechanism;
a signal comparison module configured to determine an actual rotation period of water pump gear based on the target pulse signal, and compare the actual rotation period with a preset rotation period to obtain a comparison result; and
a signal control module configured to control a driving signal according to the comparison result based on a proportional-integral algorithm, where the driving signal is a signal generated based on the target pulse signal.

In addition, in order to achieve the above purpose, the present application also provides a signal control device, including: a memory, a processor, and a computer program stored in the memory and executable on the processor, and the computer program is configured to implement the signal control method as described above.

In addition, in order to achieve the above purpose, the present application also provides a storage medium, which is a computer-readable storage medium, a computer program is stored on the computer-readable storage medium, and when the computer program is executed by a processor, the signal control method as described above is implemented.

In addition, in order to achieve the above purpose, the present application also provides a computer program product, including a computer program, and when the computer program is executed by a processor, the signal control method as described above is implemented.

In the technical solution proposed in the present application, a target pulse signal is obtained by a Hall sensor based on an interrupt-triggered response mechanism; an actual rotation period of a water pump gear is determined based on the target pulse signal, and the actual rotation period is compared with a preset rotation period to obtain a comparison result; and a driving signal is controlled according to the comparison result based on a proportional-integral algorithm, where the driving signal is a signal generated based on the target pulse signal. The present application captures the target pulse signal by the Hall sensor based on the interrupt-triggered mechanism, calculates the actual rotation period of the water pump gear, compares the actual rotation period with the preset rotation period, and adjusts the driving signal, thereby achieving real-time monitoring and precise control of water pump data, improving the response speed and control accuracy of the system, and ensuring the stable operation of the water pump.

### BRIEF DESCRIPTION OF THE DRAWINGS

The drawings incorporated in the specification form a part of the specification and shows embodiments corresponding to the present application, and are used to explain the principle of the present application together with the specification

In order to illustrate the technical solutions in the embodiments of the present application or in the related art more clearly, the following briefly introduces the accompanying drawings required for the description of the embodiments or the related art. Obviously, for those skilled in the art, other drawings can also be obtained according to the structures shown in these drawings without any creative effort.

FIG. 1 is a flow chart of a signal control method according to an embodiment of the present application.

FIG. 2 is a flow chart of the signal control method according to another embodiment of the present application.

FIG. 3 is a schematic diagram of a module structure of a signal control apparatus according to an embodiment of the present application.

FIG. 4 is a schematic diagram of a device structure of a hardware operating environment involved in the signal control method according to an embodiment of the present application.

The achievement of the objectives, functional features, and advantages of the present application will be further explained with reference to the embodiments and accompanying drawings.

### DETAILED DESCRIPTION OF THE EMBODIMENTS

It should be understood that the specific embodiments described herein are only used to explain the present application, and are not intended to limit the present application.

In order to better understand the technical solution of the present application, a detailed description will be given below in combination with the accompanying drawings and specific implementation methods.

In the existing signal control technology for water flossers, due to uncertain factors such as assembly tolerances, friction losses, and thermal deformation in the mechanical transmission between the motor and the water pump gear, significant deviations often exist between the actual rotation speed data and the theoretical values, thereby making it impossible to accurately control the driving signal of the water pump.

Therefore, in order to overcome the above defects, the present application provides a solution that uses a Hall sensor to capture the target pulse signal based on an interrupt-triggered mechanism, calculates the actual rotation cycle of the water pump gear, compares the actual rotation cycle with the preset rotation cycle, and adjusts the driving signal. This achieves real-time monitoring and precise control of the water pump data, improves the response speed and control accuracy of the system, and ensures the stability of the water pump operation.

It should be noted that the executing subject of each embodiment of the present application may be a computing service system with data processing, network communication, and program execution functions, such as an electronic system or a signal control system capable of realizing the above functions. The following takes a signal control system (hereinafter referred to as “the system”) as an example to illustrate the following embodiments.

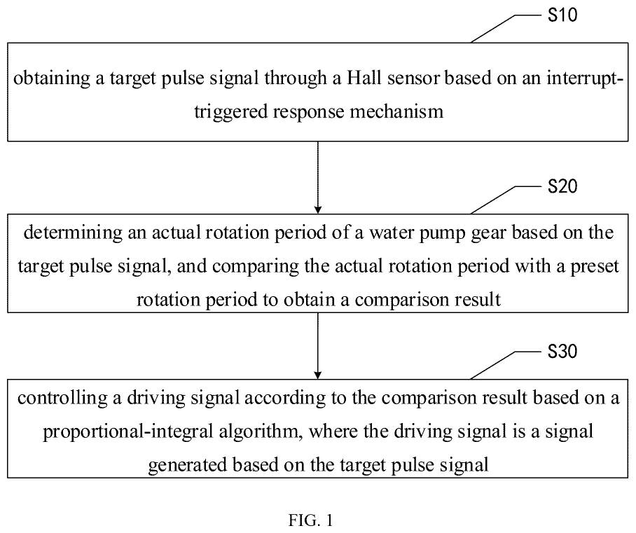

Based on this, the present application provides a signal control method. Referring to FIG. 1, FIG. 1 is a flow chart of the signal control method according to an embodiment of the present application.

In this embodiment, the signal control method includes steps S10~S30:

Step S10, obtaining a target pulse signal through a Hall sensor based on an interrupt-triggered response mechanism.

In the field of equipment health monitoring and intelligent control, taking a water flosser as an example, an open-loop motor-driven water pump control scheme is generally adopted, where a rotation speed of the water pump is indirectly controlled by adjusting an input voltage, thereby affecting the outlet water pressure and water flow. However, due to uncertain factors such as assembly tolerances, friction losses, and thermal deformation in the mechanical transmission between the motor and the water pump gears, the actual rotation speed often deviates significantly from the theoretical value. This a nonlinear relationship between “rotation speed and water pressure” prevents the conventional control method from accurately maintaining a constant water pressure, resulting in water pressure fluctuations and inconsistent water flow during user operation, which seriously impairs cleaning performance and user experience. For example, when the water flosser operates under a high-load condition, a reduction in motor torque may lead to rotation speed slip and an abrupt drop in water pressure; while the water flosser is at low-speed gears, mechanical resonance may cause high-frequency vibration, further exacerbating the deterioration of control accuracy.

The present application fundamentally overcomes the above defects through a closed-loop feedback mechanism and multi-dimensional signal fusion technology. Specifically, a permanent magnet array is integrated on the water pump gear, and a Hall sensor is provided at the circuit board. A precise rotation speed detection reference is established using pulse signals generated by the rotation of magnetic poles. The rising edge and the falling edge of the Hall pulses (e.g., all level transition points) are captured in real time through an interrupt-triggered response mechanism. After high-frequency noise is filtered out by the hardware filtering capacitor (10 kΩ resistor in combination with a 104 pF capacitor), an adaptive filtering algorithm is adopted to calibrate the signal timing. Based on a dynamically calibrated preset rotation period (T=60×1000 ms/target rotation speed), the system regulates the duty cycle of the driving signal in real time by using a proportional-integral (PI) algorithm through comparison of the difference between the actual rotation period (t) and T. When t is greater than T (i.e., insufficient rotation speed), the duty cycle of the driving signal is increased according to a proportional coefficient to raise the motor voltage and accelerate the gear; conversely, the duty cycle is decreased to suppress the rotation speed. In addition, a dead-zone compensation mechanism is innovatively introduced. When the error falls within a threshold band, an exponentially weighted moving average is adopted to buffer the regulation command, thereby avoiding high-frequency oscillation.

Specifically, the target pulse signal is first obtained through a Hall sensor based on an interrupt-triggered response mechanism. The magnet is integrated with the gear, and the Hall sensor uses an interrupt-triggered mechanism to capture the instantaneous edge signal of the magnetic pole rotation in real time.

It should be noted that the signal control method of the present application is universal and can be flexibly adapted to fluid control scenarios in various fields such as industry, home appliances, medical care, and agriculture, breaking through the dependence of traditional solutions on specific equipment. For example, in a water flosser, constant water pressure and fast response time are achieved through closed-loop control, which is suitable for high-precision cleaning requirements. In a washing machine or dishwasher, the spray arm pressure can be regulated by detecting the rotation speed of the water pump to ensure stable water flow under different washing modes. In an infusion pump, the liquid flow rate in the infusion tube is controlled through closed-loop control to realize precise titration and avoid dosage errors.

Step S20, determining an actual rotation period of a water pump gear based on the target pulse signal, and comparing the actual rotation period with a preset rotation period to obtain a comparison result.

It should be noted that the water pump gear is a core mechanical component adopted in a fluid delivery system for precisely controlling flow rate and pressure, which is formed of metal or high-strength plastic. A fixed number of permanent magnets are uniformly distributed on the surface thereof (e.g., two pairs of magnetic poles symmetrically disposed per revolution), so as to form a magnetic field distribution pattern recognizable by the Hall sensor. The present application replaces a conventional mechanical encoder through an integrated magnetic steel design, thereby avoiding contact wear and prolonging service life of the equipment. Furthermore, a gear tooth profile and magnetic pole positions of the gear are optimized through precise arrangement, so as to ensure edge sharpness of a pulse signal and reduce a misjudgment rate caused by environmental interference. In addition, a rotation period refers to a time required for the water pump gear to complete one full mechanical cycle, which reflects the dynamic characteristics of the gear meshing motion.

In an embodiment, before the step S20, the method may further include: in response to detecting that an actual water pressure reaches a target water pressure, obtaining a rotation speed of the water pump gear; and determining a preset rotation period of the water pump gear according to a corresponding relationship between a rotation speed of the water pump gear and the target water pressure.

The present application achieves precise closed-loop feedback of the rotation speed of the water pump gear through timing feature extraction and dynamic calibration, where the core process thereof can be divided into three functional modules: signal time base calibration, parameter dynamic matching, and multi-order error processing.

Specifically, during the signal time base calibration phase, the system constructs rotation speed measurement reference based on timing feature of a target pulse sequence. When the Hall sensor detects magnetic poles alternately passing by, a hardware interrupt mechanism precisely captures an instantaneous point of a rising edge or a falling edge of each pulse signal. By continuously recording time intervals between two adjacent valid pulses, and in combination with a fixed number of magnetic pole pairs in the gear structure (e.g., two pairs of magnetic poles per revolution), an actual rotation period of the gear can be derived. For example, one pulse signal is generated when each pair of magnetic poles passes the sensor. When a time span of N complete pulse sequences is monitored to be ΔT, an actual rotation speed can be calculated indirectly by statistically analyzing the correspondence between the number of pulses and the time intervals. This process avoids the conventional method of directly relying on a tachometer, and instead implements non-contact measurement by utilizing inherent characteristics of the mechanical structure.

During the parameter dynamic matching stage, the preset rotation period is not fixed value, but a dynamic parameter intelligently adjusted according to real-time operating conditions of the system. When the actual water pressure is detected to reach a target value, the system determines a reference period through a built-in rotation speed-water pressure correlation model. The model is constructed based on historical operation data. For example, under steady-state operating conditions, water pressure and rotation speed exhibit an approximately inverse relationship, and an online learning mechanism is adopted to compensate for nonlinear deviations caused by factors such as temperature variations and pipeline resistance. In addition, the system adopts a sliding window algorithm to perform weighted fusion on parameters of a plurality of recent operating points. For example, weights of 70%, 20%, and 10% are respectively assigned to rotation speed data obtained during the latest three stable operations, so as to finally generate a preset period reference value having both robustness and real-time performance.

During the multi-order error processing stage, the system refines error characteristics through a three-level comparison mechanism. First, an absolute deviation between the actual rotation period and the preset rotation period is calculated. Then, dynamic classification is performed in combination with an error variation trend. For example, if the deviation is continuously maintained within ±1%, it is determined as a steady-state error, and an exponential smoothing method is adopted to suppress high-frequency noise; if the deviation exceeds ±2% and remains in a stable direction, a proportional regulation mechanism is triggered; for abrupt errors (e.g., instantaneous load fluctuations), a trend is predicted in advance through differential compensation. In particular, the system is provided with an error dead-zone threshold, and the output of regulation commands is suspended when the error approaches zero, thereby effectively avoiding problems caused by measurement noise or oscillation. All comparison results generate a comprehensive control command through multi-dimensional feature extraction (including error amplitude, rate of change, durations, etc.).

Through a collaborative design of a hardware time base and a software algorithm, the whole process converts pulse signals into quantifiable rotation speed information, and implements a closed-loop chain from signal acquisition to control decision through dynamic calibration and multi-level error processing, so as to ensure stability and accuracy of the system under complex operating conditions.

Step S30, controlling a driving signal according to the comparison result based a proportional-integral algorithm, where the driving signal is a signal generated based on the target pulse signal.

It should be noted that the driving signal is a core control medium of the closed-loop control system of the present application, which is essentially a set of digital command signals for precisely controlling the movement of the water pump motor, and generally exists in the form of a pulse width modulation (PWM) waveform. In the present application, the driving signal serves as a final execution command of the closed-loop control system; that is, the driving signal, as a final control command, directly determines the motor rotation speed and the water pressure output.

In an embodiment, the step S30 may include: in response to the comparison result indicating that the actual rotation period is greater than the preset rotation period, increasing a duty cycle of the driving signal by using the proportional-integral algorithm; in response to the comparison result indicating that the actual rotation period is less than the preset rotation period, decreasing the duty cycle of the driving signal by using the proportional-integral algorithm; and in response to the comparison result indicating that a difference between the actual rotation period and the preset rotation period reaches a preset difference range, performing buffer control on the driving signal by exponential weighted moving average according to a dead-zone control algorithm.

The present application achieves closed-loop optimization control of the driving signal via a dynamic regulation strategy. Its core lies in converting an error signal into an executable power command. The specific process may be divided into: proportional regulation for rapid response, integral regulation for eliminating steady-state deviation, dead zone compensation for suppressing oscillation, and adaptive parameter optimization.

Specifically, in the proportional regulation stage for rapid response, the system adjusts the duty cycle of the driving signal according to the magnitude of the error signal. For example, when the actual rotation period is lower than a set value, the error signal is positive, and the control module gradually increases the duty cycle by a proportional coefficient (e.g., 0.8 to 1.2 times) to accelerate the motor rotation speed; conversely, the duty cycle is decreased. The proportional regulation is characterized by rapid response, which can suppress most errors within several tens of milliseconds.

During the integral regulation stage for eliminating steady-state deviation, the system performs time accumulation on the error signal and generates a compensation command through integral operation. For example, if the error persists and is not completely eliminated, the integral term gradually increases (or decreases) the regulation amount until the error is reduced to zero. The selection of the integral coefficient directly affects the steady-state accuracy and anti-interference capability of the system, and is generally set to a relatively small value (e.g., 0.01 to 0.1) to avoid excessive sensitivity. In practical applications, integral regulation operates in parallel with proportional regulation to form a classic proportional-integral control structure, which not only ensures dynamic response speed but also eliminates long-term deviations.

During the dead zone compensation stage for suppressing oscillation, a threshold interval (e.g., a ±0.5% error band) is set in the system to address frequent regulations within a small error range. When the error falls within this interval, the driving signal maintains its current state, thereby avoiding mechanical resonance or high-frequency current oscillation caused by minor fluctuations. In addition, when switching control modes (e.g., transitioning from proportional-integral regulation to buffer control), an exponential weighted moving average method is adopted to perform smoothing processing on the driving signal. For example, the current duty cycle and the new command are fused according to a weighting ratio (e.g., 7:3) to ensure a smooth transition process.

During the adaptive parameter optimization stage, the system dynamically adjusts the proportional-integral parameters according to operating conditions to adapt to complex working scenarios. For example, when the water pump is detected to be in a high-load region, the proportional coefficient is appropriately increased to improve regulation sensitivity; during low-speed steady-state operation, the integral coefficient is reduced. The parameter optimization algorithm is further combined with a historical data learning mechanism: by recording optimal parameter combinations under various operating conditions (e.g., error variation rate, regulation time, etc.), a fuzzy rule base or neural network model is constructed to realize online self-tuning of parameters. For example, when the error variation rate exceeds a threshold value, the proportional coefficient is automatically increased by 30% to enhance the system robustness against sudden load changes.

For ease of understanding, description is made with reference to an application example of a water flosser. In a high-pressure water flosser scenario, magnets are mounted at the water pump gear, and a Hall sensor is mounted at a circuit board adjacent to the water pump gear. Rotation of the water pump gear drives the magnets to rotate. When a magnet passes the Hall sensor, i.e., when the water pump gear rotates one full cycle, the Hall sensor outputs a pulse signal. Assuming a user sets a target water pressure of 150 psi (corresponding to a gear rotation speed n_set=300 rpm, T=20 ms). The system firstly performs a pre-calibration process: gradually increasing the water pump rotation speed while detecting the outlet water pressure with a water pressure sensor. When the water pressure stabilizes at 150 psi, the actual rotation speed n_ref =295 rpm (taking mechanical losses into account) is recorded, and the preset rotation period T=60×1000/295 ≈20.34 ms is calculated. Subsequently, the Hall sensor continuously monitors gear rotation. If the actual rotation period t=22 ms (rotation speed dropping to 274 rpm) is detected, the PI regulation is triggered: the error e=20.34-22 =−1.66 ms. After the integral term is cumulatively compensated, the duty cycle of the driving signal is increased from 50% to 62%, and the motor voltage is correspondingly increased by 15%, so that the rotation speed returns to the set value.

In practical use, when the user switches to a strong flushing mode, an instantaneous flow demand may cause a sudden change in gear load. Traditional systems may suffer from an abrupt drop in water pressure due to rotation speed lag, while the present application captures changes in the pulse signal in real time via an interrupt-triggered response mechanism (response time is less than 5 μs), and completes regulation of proportional-integral parameters within 10 ms, ensuring that water pressure fluctuation is controlled within ±3%. In addition, the synergistic effect of the filtering capacitor and the adaptive filtering algorithm effectively suppresses electromagnetic noise interference caused by water flow pulsation inside the water flosser, ensuring the reliability of signal detection. During long-term operation, the system identifies abnormal conditions such as bearing wear by monitoring motor current ripple. When a current distortion rate exceeding 12% is detected, gradient speed-reduction protection is automatically triggered (e.g., stepwise regulation at 30% to 50% to 70% duty cycle), so as to avoid motor overload damage while maintaining a minimum cleaning function.

In the present embodiment, a Hall sensor is configured to capture a target pulse signal based on an interrupt-triggered mechanism, so as to calculate the actual rotation period of the water pump gear. When the actual water pressure reaches the target water pressure, the rotation speed of the water pump gear is acquired to determine the preset rotation period, thereby realizing coordinated control of water pump rotation speed and water pressure. By comparing the actual rotation period with the preset rotation period and adjusting the driving signal, real-time monitoring and precise control of water pump data are realized, which improves the response speed and control accuracy of the system and ensures stable operation of the water pump. Furthermore, according to a comparison result between the actual rotation period and the preset rotation period, the duty cycle of the driving signal is adjusted through a proportional-integral algorithm. When the difference between the actual rotation period and the preset rotation period reach a preset range, buffer control is performed using a dead-zone control algorithm, thereby realizing precise control of the water pump rotation speed and improving the control performance of the system. The dead-zone control algorithm prevents oscillation of the system caused by frequent regulations.

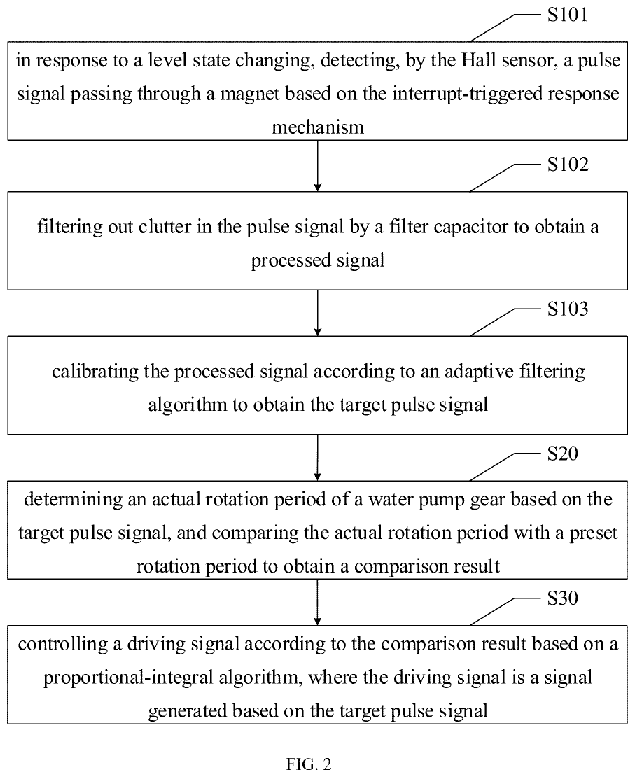

Based on the above embodiment of the present application, in another embodiment of the present application, the content that is the same as or similar to that in the above embodiment described above can be referred to the above description and will not be repeated hereafter. Based on this, please refer to FIG. 2, the step S10 may include steps S101~S103:

Step S101, in response to a level state changing, detecting, by the Hall sensor, pulse signal passing through a magnet based on the interrupt-triggered response mechanism.

It can be understood that the system monitors a level state of the Hall sensor in real time through a hardware interrupt line. The Hall element generates a millivolt-level voltage pulse under the action of a magnetic field of the permanent magnet. When the magnet rotates to a sensing surface of the sensor, the change in the magnetic field direction causes a jump in the output level (e.g., from a high level to a low level). The hardware circuit design adopts a Schmitt trigger structure to convert the raw level change into a clean edge signal, and sends an immediate notification to a processor through an interrupt request line. This asynchronous interrupt-triggered response mechanism enables the system to suspend the current task and prioritize signal processing, thereby avoiding a delay caused by polling detection and ensuring the capture of the most accurate physical event nodes.

Step S102, filtering out clutter in the pulse signal by a filter capacitor to obtain a processed signal.

It should be noted that the filter capacitor is a capacitor having a specific capacitance value, which is connected in series or parallel in a circuit to suppress high-frequency components by utilizing a high-frequency impedance characteristic of the capacitor with respect to alternating current signals, while providing a low-impedance path for direct current signal or low-frequency signal. For example, in a Hall signal preprocessing circuit, a 104 pF capacitor and a 10 kΩ resistor are adopted to form a first-order resistor-capacitor (RC) filter network (time constant T=RC≈10 ms), which can effectively attenuate high-frequency noise above 1 kHz while allowing a main frequency signal (e.g., several hundred Hz) generated by gear rotation to pass through.

Step S103, calibrating the processed signal according to an adaptive filtering algorithm to obtain the target pulse signal.

It should be understood that the signal conditioning stage focuses on solving environmental interference and signal integrity problems. The raw pulse signal is often mixed with multiple interference sources such as mechanical vibration and electromagnetic noise. To this end, a two-stage filtering architecture is adopted: the first stage is an RC low-pass filter composed of a resistor and a capacitor (with a typical cutoff frequency of 1 kHz) to remove high-frequency glitches, and the second stage performs dynamic compensation through an adaptive digital filter. The filter has automatic learning capability and can optimize filtering parameters in real time according to operating conditions, for example, enhancing suppression of low-frequency drift under low-speed operating conditions, while focusing on improving the pass rate of high-frequency components under high-speed operating conditions. This dynamic adaptation characteristics enable the system to maintain stable signal extraction within different rotation speed ranges, thereby improving the effective signal-to-noise ratio.

In an embodiment, the step S103 in this embodiment may include: determining optimal filter coefficient according to the adaptive filtering algorithm, and adjusting a filter parameter based on the optimal filter coefficient to obtain an optimized signal; and calibrating the optimized signal by comparing the optimized signal with preset pulse information to obtain the target pulse signal.

It can be understood that generation of the final target pulse signal requires precise timing calibration. Specifically, the system identifies complete pulse cycles conforming to the characteristics by comparing the signal after filtering with a preset ideal pulse template (including characteristic parameters such as amplitude threshold, rising edge slope, and pulse width range) using a point-by-point comparison algorithm. For signal points with blurred edges or severe interference, a time-window resampling mechanism may be introduced: a pulse is regarded as valid only when the minimum pulse width requirement is satisfied in three consecutive detection cycles, thereby effectively eliminating misjudgments caused by transient interference. The entire calibration process is completed within microseconds, ensuring the real-time performance and accuracy of signal acquisition.

In this embodiment, when the Hall sensor detects a level change, a pulse signal is captured and processed through a filter capacitor. An adaptive filtering algorithm is applied to calibrate the processed signal to obtain a target pulse signal, thereby improving the anti-interference capability of the pulse signal and ensuring signal accuracy. Through adaptive filtering, the system's adaptability to different operating conditions is improved. Furthermore, optimal filter coefficients are determined based on the adaptive filtering algorithm to adjust filter parameters. The optimized signal is compared with preset pulse information, and calibration is performed to obtain the target pulse signal. This further optimizes the accuracy of the pulse signal and improves system reliability. Through comparative calibration, the consistency between the target pulse signal and the preset information is ensured.

In an embodiment, after the step S30 in the present embodiment, the method may further include:
identifying an operating state of a motor according to the rotation speed of the water pump gear to obtain an identification result, and adjusting a parameter of the proportional-integral algorithm according to the operating state of the motor to obtain a updated parameter;
in response to the identification result being abnormal, controlling the driving signal in combination with the updated parameter; or
in response to the identification result being abnormal, gradually reducing the rotation speed of the water pump gear through the driving signal until shutdown protection is triggered.

It should be noted that, with respect to exception handling and protection mechanisms, the system continuously monitors rotation speed data (e.g., revolutions per minute) of the water pump gear through the Hall sensor, and performs multi-dimensional analysis in combination with historical operating characteristics to determine the motor state. For example, when the rotation speed is stable within a range of ±5% of a set value with smooth fluctuation, a normal operating state is determined; if the rotation speed continuously decreases by more than 10% accompanied by an increase in current ripple rate, an overload condition is identified; if stepwise fluctuation or complete stall of the rotation speed occurs, a jamming or locked-rotor anomaly is determined; and if the rotation speed exhibits a slow decay trend (e.g., a weekly decrease of more than 1%) along with current harmonic distortion, a potential fault such as bearing wear is identified.

Based on the state recognition, the system may dynamically optimize parameters of the proportional-integral algorithm through a fuzzy inference rule base. For example, under an overload condition, the proportional coefficient is increased to accelerate response to rotation speed deviation, while the integral coefficient is decreased to avoid over-compensation. In a bearing wear scenario, the proportional coefficient is reduced to suppress oscillation, and the integral coefficient is increased to enhance compensation capability against long-term decay. This parameter adaptation mechanism ensures a high degree of matching between the regulation strategy and operating condition requirements by matching anomaly types with preset rules in real time, thereby enabling more accurate and efficient adjustment of the duty cycle.

For the handling of abnormal states, the system adopts a hierarchical protection strategy. In the case of recoverable abnormalities (e.g., minor jamming), the motor operation is maintained based on the parameters after optimizing, while a human-machine interface prompts the user to inspect the equipment. If the anomaly cannot be alleviated (e.g., complete impeller blockage), a gradient speed-reduction mechanism is activated to gradually shut down the motor at a preset rate (e.g., reducing the duty cycle by 10% every 100 ms), and the system monitors whether the current drops back to a safe range. When the rotation speed falls below a critical threshold (e.g., less than 100 rpm) or the current continuously exceeds a standard value, a hardware circuit-breaking protection is triggered to cut off the driving signal and activate a buzzer alarm, thereby ensuring equipment safety.

For ease of understanding, description is provided in combination with an application example of a water flosser. The application of the present application in the field of water flossers implements full-process closed-loop management from high-speed flushing to abnormal shutdown through multi-state intelligent regulation and protection mechanisms. Taking four typical scenarios as examples: “normal cleaning—strong flushing—sudden jamming—long-term wear”, the system monitors the gear rotation speed (e.g., revolutions per minute) and current ripple rate in real time through the Hall sensor, recognizes the motor state in combination with historical data, dynamically optimizes control parameters, and finally ensures equipment safety and user experience through hierarchical protection. Specific details are as follows.

Normal cleaning mode: When a user sets a water pressure of 100 psi, the system pre-calibrates the gear rotation speed to 250 rpm. The Hall sensor continuously detects that the rotation speed is stable at 245 to 255 rpm (fluctuation ±5%) and the current ripple rate is lower than 5%. At this time, the proportional-integral algorithm adopts default parameters (κ_p=0.7, κ_i=0.08), the duty cycle of the driving signal is maintained at 55% to 60%, and the output voltage is 12 V, ensuring stable water flow with water pressure fluctuation of less than or equal to 3%. The user perceives no obvious pressure variation, and a balance between cleaning efficiency and comfort is achieved.

Strong flushing mode: When the user switches to a 150 psi gear, if the nozzle is slightly blocked by foreign matter, the gear rotation speed drops from 250 rpm to 200 rpm (a 20% decrease), and the current ripple rate rises to 20%. The system activates an overload response through a fuzzy rule: “rotation speed deviation greater than 10% and current ripple rate greater than 15%”: the proportional coefficient is increased to 1.2, the integral coefficient is decreased to 0.05, the drive duty cycle is rapidly raised from 55% to 70%, and the voltage is increased to 14.4 V to compensate for torque loss. The water pressure recovers to 145 psi (fluctuation ±5 psi) within 20 ms. If the blockage is not completely removed, the system further reduces the duty cycle to 60% and prompts “Please check the nozzle” via the human-machine interface to realize proactive maintenance notification.

Sudden jamming scenario: If residual water droplets cause the impeller to briefly stall the rotation speed may plummet from 200 rpm to 100 rpm and stall, with the current ripple rate soaring to 30%. After recognizing the “stepwise speed reduction” anomaly, the system switches to a fast suppression mode (κ_p=0.3, κ_i=0.15), the duty cycle is urgently reduced to 30%, and the voltage is lowered to 7.2 V to reduce mechanical stress. A gradient speed reduction is then initiated: the duty cycle is decreased by 5% every 100 ms until the rotation speed recovers to above 150 rpm. If no improvement is observed after 30 seconds, a buzzer alarm is triggered and the driving signal is cut off, and “Fault: Please clean the nozzle” is displayed to prevent motor damage due to overload.

Long-term wear condition: After 500 hours of continuous use, bearing wear causes the rotation speed to decrease by approximately 1% per week. The system determines a bearing anomaly by detecting a slow drop in rotation speed (e.g., from 250 rpm to 230 rpm) and an increase in current harmonic distortion rate. At this time, the proportional coefficient is reduced to 0.4 to suppress oscillation, the integral coefficient is increased to 0.15 to compensate for long-term deviation, the drive duty cycle is stabilized at 50% to 55%, and the voltage is maintained at 10.8 V. The user may perceive a slight water pressure decay (e.g., from 100 psi to 97 psi), but the system gradually optimizes parameters via an online learning algorithm to extend the service life of the equipment. If wear worsens such that the rotation speed falls below 100 rpm, hardware circuit-breaking protection is triggered to ensure safe shutdown.

Through multi-source data fusion and dynamic parameter regulation, multiple advantages are realized in the water flosser scenarios, for example: Control precision: water pressure fluctuation is reduced from ±10% in traditional solutions to ±3%, meeting high-end cleaning requirements; Response speed: regulation time under abnormal conditions is less than 20 ms, avoiding water flow interruption that affects user experience; Reliability: bearing wear warning accuracy reaches 95%, and the fault shutdown rate is reduced by 60%; Energy efficiency optimization: dynamic duty cycle regulation reduces energy consumption by 18% and extends battery life by 30%.

In the present embodiment, the rotation speed of the water pump gear is determined in real time according to the pulse signal output by the Hall sensor, the operating state of the motor is recognized, and parameters of the proportional-integral algorithm are adjusted or the gear rotation speed is gradually reduced until shutdown protection is implemented according to the recognition result, thereby realizing real-time monitoring and intelligent control of the operating state of the motor and improving the safety of the system. Furthermore, damage to the motor caused by abnormal operating states is avoided by means of the shutdown protection measures.

It should be noted that the above examples are only for understanding the present application and do not constitute a limitation on the signal control method of the present application. Any simple modifications based on this technical concept are within the protection scope of the present application.

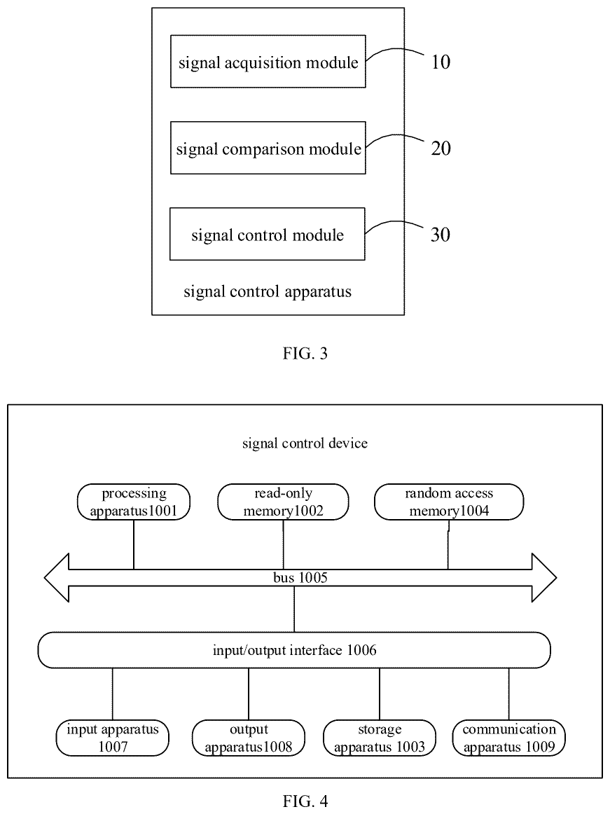

The present application also provides a signal control apparatus, as shown in FIG. 3, and the signal control apparatus includes: a signal acquisition module 10, a signal comparison module 20 and a signal control module 30.

The signal acquisition module 10 is configured to obtain a target pulse signal through a Hall sensor based on an interrupt-triggered response mechanism.

The signal comparison module 20 is configured to determine an actual rotation period of a water pump gear based on the target pulse signal, and compare the actual rotation period with a preset rotation period to obtain a comparison result.

The signal control module 30 is configured to control a driving signal according to the comparison result based on a proportional-integral algorithm, where the driving signal is a signal generated based on the target pulse signal.

The signal control device provided in the present application, adopting the signal control method described in the above embodiments, can solve the technical problem that the prior art cannot accurately control the driving signal of the water pump. Compared with the prior art, the beneficial effects of the signal control device provided in the present application are the same as the beneficial effects of the signal control method described in the above embodiments, and other technical features in the signal control device are the same as the features disclosed in the methods of the above embodiments, and will not be repeated here.

The present application provides a signal control device, which includes: at least one processor; and a memory communicatively connected to the at least one processor; where the memory stores instructions executable by the at least one processor, and the instructions are executed by the at least one processor so that the at least one processor executes the signal control method in the above embodiment.

Referring to FIG. 4, which shows a schematic structural diagram of a signal control device suitable for implementing embodiments of the present application. The signal control device in embodiments of the present application may include, but is not limited to, mobile terminals such as mobile phones, laptops, digital broadcast receivers, Personal Digital Assistants (PDAs), PADs, Portable Media Players (PMPs), in-vehicle terminals (e.g., in-vehicle navigation terminals), and fixed terminals such as digital TVs and desktop computers. The signal control device shown in FIG. 4 is merely an example and should not impose any limitations on the functionality and scope of use of embodiments of the present application.

As shown in FIG. 4, the signal control device may include a processing apparatus 1001 (e.g., a central processing unit, a graphics processing unit, etc.), which can perform various appropriate actions and processes according to a program stored in a read-only memory 1002 or a program loaded from a storage apparatus 1003 into a random access memory 1004. The random access memory 1004 also stores various programs and data required for the operation of the signal control device. The processing apparatus 1001, the read-only memory 1002, and the random access memory 1004 are connected to each other via a bus 1005. An input/output interface 1006 is also connected to the bus 1005. Typically, the following systems can be connected to the input/output interface 1006: input apparatus 1007, including: for example, touchscreens, touchpads, keyboards, mice, image sensors, microphones, accelerometers, gyroscopes, etc.; output apparatus 1008 including, for example, liquid crystal displays (LCDs), speakers, vibrators, etc.; storage apparatus 1003 including, for example, magnetic tapes, hard disks, etc.; and communication apparatus 1009. The communication apparatus 1009 can allow the signal control device to communicate with other devices wirelessly or by wire to exchange data. Although the signal control device with various systems is shown in the figure, it should be understood that it is not required to implement or have all the systems shown. More or fewer systems can be implemented or alternative arrangements can be used.

Specifically, according to the embodiments of the present application, the processes described above with reference to the flowcharts can be implemented as a computer software program. For example, embodiments disclosed in the present application include a computer program product, which includes a computer program carried on a computer-readable medium, and the computer program includes a program code for executing the methods shown in the flowchart. In such an embodiment, the computer program can be downloaded and installed from a network via a communication apparatus, or installed from storage apparatus 1003, or installed from read-only memory 1002. When the computer program is executed by processing apparatus 1001, the above functions defined in the method of the embodiments disclosed in the present application are executed.

The signal control device provided in the present application adopts the signal control method described in the above embodiments, which can solve the technical problem that the prior art cannot accurately control the driving signal of the water pump. Compared with the prior art, the beneficial effects of the signal control device provided in the present application are the same as the beneficial effects of the signal control method described in the above embodiments, and other technical features of the signal control device are the same as the features disclosed in the previous embodiment method, and will not be repeated here.

It should be understood that the various parts disclosed in the present application can be implemented using hardware, software, firmware, or a combination thereof. In the description of the above embodiments, specific features, structures, materials, or characteristics can be combined in one or more embodiments or examples in any suitable manner.

The above description is only a specific embodiment of the present application, but protection scope of the present application is not limited thereto. Those skilled in the art can easily think of changes or substitutions within the technical scope disclosed in the present application, which should be included in the protection scope of the present application. Therefore, the protection scope of the present application should be based on the protection scope of the claims.

The present application provides a computer-readable storage medium having computer-readable program instructions (i.e., a computer program) stored thereon, and the computer-readable program instructions are used to execute the signal control method described in the above embodiments.

The computer-readable storage medium provided in the present application may be, for example, a USB flash drive, but is not limited to, electrical, magnetic, optical, electromagnetic, infrared, or semiconductor systems or devices, or any combination thereof. More specific examples of computer-readable storage media may include, but are not limited to: electrical connections having one or more wires, portable computer disks, hard disks, random access memory (RAM) , read-only memory (ROM) , erasable programmable read-only memory (EPROM) or flash memory, optical fibers, portable compact disk read-only memory (CD-ROM), optical storage devices, magnetic storage devices, or any suitable combination thereof. In this embodiment, the computer-readable storage medium may be any tangible medium containing or storing a program, which may be used by or in combination with an instruction execution system or device. The program code contained on the computer-readable storage medium may be transmitted using any suitable medium, including but not limited to: wires, optical cables, Radio Frequency (RF), etc., or any suitable combination thereof.

The computer-readable storage medium may be included in the signal control device; or may exist independently without being assembled into the signal control device.

The computer-readable storage medium carries one or more programs. When the one or more programs are executed by the signal control device, the signal control device is configured to: obtain a target pulse signal through a Hall sensor based on an interrupt-triggered response mechanism; determine an actual rotation period of a water pump gear based on the target pulse signal, and compare the actual rotation period with a preset rotation period to obtain a comparison result; and control a driving signal according to the comparison result based on a proportional-integral algorithm, where the driving signal is a signal generated based on the target pulse signal.

The computer program code for performing the operation of the present application can be written in one or more programming languages or a combination thereof, and the programming languages include object-oriented programming languages such as Java, Smalltalk, C++, and conventional procedural programming languages such as “C” language or similar programming languages. The program code can be executed completely on the user's computer, partially on the user's computer, as an independent software package, partially on the user's computer and partially on a remote computer, or completely on a remote computer or server. In case of involving a remote computer, the remote computer may be connected to the user computer through any type of network, including a local area network (LAN) or a wide area network (WAN), or may be connected to an external computer (e.g., through the Internet using an Internet service provider).

The flowchart and block diagram in the accompanying drawings illustrate the possible architecture, function and operation of the system, method and computer program product according to various embodiments of the present application. In this regard, each square box in the flow chart or block diagram can represent a module, a program segment or a part of a code, and the module, the program segment or a part of the code contains one or more executable instructions for realizing the specified logical function. It should also be noted that in some alternative implementations, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The modules involved in the embodiments described in the present application may be implemented by software or hardware, where the name of the module does not constitute a limitation on the unit itself in some cases.

The present application is a computer-readable storage medium, which stores computer-readable program instructions (i.e., a computer program) for executing the above-described signal control method, and can solve the technical problem that the prior art cannot accurately control the driving signal of the water pump. Compared with the prior art, the beneficial effects of the computer-readable storage medium provided in the present application are the same as the beneficial effects of the signal control method provided in the above embodiments, and will not be repeated here.

The present application also provides a computer program product, including a computer program, and when the computer program is executed by a processor, the signal control method as described above is implemented.

The computer program product provided in the present application can solve the technical problem that the prior art cannot accurately control the driving signal of the water pump. Compared with the prior art, the beneficial effects of the computer program product provided in the present application are the same as the beneficial effects of the signal control method provided in the above embodiments, and will not be repeated here.

The above are only some embodiments of the present application, and do not limit the scope of the present application thereto. Under the concept of the present application, equivalent structural transformations made according to the description and drawings of the present application, or direct/indirect application in other related technical fields are included in the scope of the present application.

What is claimed is:

1. A signal control method, comprising:
obtaining a target pulse signal through a Hall sensor based on an interrupt-triggered response mechanism;
determining an actual rotation period of a water pump gear based on the target pulse signal, and comparing the actual rotation period with a preset rotation period to obtain a comparison result; and
controlling a driving signal according to the comparison result based on a proportional-integral algorithm, wherein the driving signal is a signal generated based on the target pulse signal.

2. The signal control method according to claim 1, wherein the obtaining the target pulse signal through the Hall sensor based on the interrupt-triggered response mechanism comprises:
in response to a level state changing, detecting, by the Hall sensor, a pulse signal passing through a magnet based on the interrupt-triggered response mechanism;
filtering out clutter in the pulse signal by a filter capacitor to obtain a processed signal; and
calibrating the processed signal according to an adaptive filtering algorithm to obtain the target pulse signal.

3. The signal control method according to claim 2, wherein the calibrating the processed signal according to the adaptive filtering algorithm to obtain the target pulse signal comprises:
determining an optimal filter coefficient according to the adaptive filtering algorithm, and adjusting a filter parameter based on the optimal filter coefficient to obtain an optimized signal; and
calibrating the optimized signal by comparing the optimized signal with preset pulse information to obtain the target pulse signal.

4. The signal control method according to claim 1, wherein the controlling the driving signal according to the comparison result based on the proportional-integral algorithm comprises:
in response to the comparison result indicating that the actual rotation period is greater than the preset rotation period, increasing a duty cycle of the driving signal by using the proportional-integral algorithm;
in response to the comparison result indicating that the actual rotation period is less than the preset rotation period, decreasing the duty cycle of the driving signal by using the proportional-integral algorithm; and
in response to the comparison result indicating that a difference between the actual rotation period and the preset rotation period reaches a preset difference range, performing buffer control on the driving signal by exponential weighted moving average according to a dead-zone control algorithm.

5. The signal control method according to claim 1, wherein before the determining the actual rotation period of the water pump gear based on the target pulse signal, and comparing the actual rotation period with the preset rotation period to obtain the comparison result, the method further comprises:
in response to detecting that an actual water pressure reaches a target water pressure, obtaining a rotation speed of the water pump gear; and
determining a preset rotation period of the water pump gear according to a corresponding relationship between a rotation speed of the water pump gear and the target water pressure.

6. The signal control method according to claim 1, wherein after the controlling the driving signal according to the comparison result based on the proportional-integral algorithm, the method further comprises:
identifying an operating state of a motor according to the rotation speed of the water pump gear to obtain an identification result, and adjusting a parameter of the proportional-integral algorithm according to the operating state of the motor to obtain an updated parameter;
in response to the identification result being abnormal, controlling the driving signal in combination with the updated parameter; or
in response to the identification result being abnormal, gradually reducing the rotation speed of the water pump gear through the driving signal until shutdown protection is triggered.

7. A signal control apparatus, comprising:
a signal acquisition module configured to obtain a target pulse signal through a Hall sensor based on an interrupt-triggered response mechanism;
a signal comparison module configured to determine an actual rotation period of a water pump gear based on the target pulse signal, and compare the actual rotation period with a preset rotation period to obtain a comparison result; and
a signal control module configured to control a driving signal according to the comparison result based on a proportional-integral algorithm, wherein the driving signal is a signal generated based on the target pulse signal.

8. A signal control device, comprising: a memory, a processor, and a signal control program stored in the memory and executable on the processor, wherein when the signal control program is executed by the processor, the signal control method according to claim 1 is implemented.

9. A non-transitory computer-readable storage medium, wherein the storage medium stores a signal control program, and when the signal control program is executed by a processor, the signal control method according to claim 1 is implemented.

10. A computer program product, comprising a signal control program, wherein when the signal control program is executed by a processor, the signal control method according to claim 1 is implemented.
